(19) United States
(12) Patent Application Publication
(10) Pub. No.: US 2012/0227529 A1
(43) Pub. Date: Sep. 13, 2012

(54) INTERMEDIATE BEARING DEVICE WITH TOOTHING REINFORCEMENT FOR STARTER

(75) Inventors: Thomas Fischer, Hildesheim (DE); Thomas Bilsing, Hann. Muenden (DE); Zsolt Pavel, Miskolc (HU)

(73) Assignee: ROBERT BOSCH GMBH, Stuttgart (DE)

(21) Appl. No.: 13/392,777

(22) PCT Filed: Aug. 18, 2010
(86) PCT No.: PCT/EP10/62037

§ 371 Date: May 14, 2012

(30) Foreign Application Priority Data
Aug. 27, 2009 (DE) 10 2009 028 926.7

(51) Int. Cl. F16H 55/14; F16H 55/06

(52) U.S. Cl. 74/434

(57) ABSTRACT

The subject matter of the present invention relates to an intermediate bearing device (1) for a cranking apparatus, in particular for a starter for cranking an internal combustion engine, comprising a toothing region (3) with a base section (4) and toothing sections (5) formed thereon, for receiving gearwheels in a bearing manner, wherein the toothing region (3) is formed as a composite toothing region (8), in which means for increasing a toothing strength are integrated, a cranking apparatus, in particular a starter for cranking an internal combustion engine, comprising an intermediate bearing device (1) according to the invention and a system comprising an internal combustion engine and a starter for cranking the internal combustion engine with a cranking apparatus according to the invention.

### BACKGROUND OF THE INVENTION

The invention relates to an intermediate bearing device for a cranking apparatus, in particular for a starter for cranking an internal combustion engine.

The invention further relates to a cranking apparatus, in particular to a starter for cranking an internal combustion engine.

In addition, the invention relates to a system comprising an internal combustion engine and a starter for cranking the internal combustion engine.

The invention relates to a system comprising a starter or starter motor and a starter having an internal reduction gear unit and gearing for reducing the rotational speed while at the same time increasing the torque.

The subject matter of the present invention is starters for motor vehicles having internal combustion engines.

Starters for motor vehicles having internal combustion engines are known from prior art, which as a rule comprise a DC electric motor for driving the internal combustion engine.

In starters or starter motors of this kind, a relay-operated fork lever system and a helical spline are, for example, responsible for a meshing with the ring gear or travel into the same. The travel, also denoted as distance or more precisely a meshing movement, consists of the following actions: A magnetic relay pulls a fork lever backward. An overrunning clutch is pushed forward via a transmission. If the relay is switched, an electric motor begins to rotate. As a result, the helical spline sitting on a drive shaft, which can also be denoted as an output shaft depending on which convention is concerned, is rotated and a dog is pushed forward over the flanks of said helical spline. This axial and radial movement in combination with a meshing spring allows the tooth gaps in the ring gear to be more easily found. The helical spline is used at the same time for the transfer of force and torque.

In starter motors, starters or other cranking apparatuses, an intermediate gearing is usually embodied as a planetary gear set having a ring gear, which is axially fixed and is accommodated in the peripheral direction in the housing in a spring-elastic manner. The sun gear is driven by a cranking motor and a speed reduction to the starting pinion results by means of the planetary gear set. This is required at the beginning of the start-up process in order to achieve a high torque at the starting pinion to crank the drive transmission of the internal combustion engine.

A cranking apparatus for internal combustion engines having a cranking motor is known from the German patent publication DE 199 27 905 A1, the drive shaft of which is operatively connected to an axially displaceable dog via intermediate gearing designed as a planetary gear set, said dog being a part of a pinion-engaging drive comprising a one-way clutch and a starting pinion. The pinion-engaging drive is brought into engagement with the ring gear of the drive transmission of the internal combustion engine. The planetary gear set has a sun gear configured on the drive shaft, said sun gear being operatively connected to an internal gear via planet gears. Said sun gear is mounted in a clutch shell, which blocks rotation against the cranking direction and is fixedly disposed in the housing of the cranking apparatus. With the aid of flyweights disposed in a pivotable manner on the planetary-gear carrier and in dependence on the rotational speed, the internal gear can be frictionally connected to said planetary-gear carrier and can release the lock on the one-way clutch in the cranking direction. As a result, a change in the gear ratio of the planetary gear set occurs.

Starters or cranking apparatuses of this type for starting internal combustion engines have been manufactured up until now with an intermediate bearing made from thermoplastic or with an intermediate bearing from thermoplastic in combination with an internal gear from sintered steel, also referred to as a sintered internal gear, and with a plurality of damping rubbers. When a load is applied to the planetary gear set having an intermediate bearing consisting of thermoplastic during the start-up process, the gear teeth on the intermediate bearing can break or melt under unfavorable force conditions. Furthermore, in the case of an intermediate bearing consisting of thermoplastic, which has an internal gear of sintered steel and a plurality of damping rubbers, the sintered internal gear can break due to the mostly thin wall thickness of the same.

### SUMMARY OF THE INVENTION

The intermediate bearing device according to the invention, the cranking apparatus according to the invention and the inventive system have in contrast to the prior art the advantage that breakage or excessive wear of teeth or of tooth systems on the intermediate bearing are prevented by means for increasing a tooth strength. A compact and very stable intermediate bearing device having a wear-resistant toothing region is realized by an optimized integration of these means. The means can be embodied as a ring consisting of material which is different from the material of the toothing region, preferably of a more wear-resistant material such as steel or sintered steel. The means can be entirely or partially integrated into said toothing region. A composite toothing region, which is optimized for the loads which may occur due to the different materials, is implemented by way of a suitable integration of said means.

Provision is made in one advantageous embodiment for the means to be configured as at least one reinforcing body which is at least partially matched to the contour of the toothing region. A plurality of bodies can be provided, which, for example, are disposed parallel to one another or in line with one another. The bodies are connected to each other in one embodiment, for example resiliently or dampeningly. It is furthermore advantageous for the composite toothing region and/or the means to extend substantially over the entire toothing region in at least one dimension, i.e. axially, radially and/or peripherally. In this way, gearwheels which are stressed over the entire periphery thereof, can be correspondingly reinforced. Alternatively, for example, in the case of only partially stressed toothing regions, only the stressed toothing regions can be correspondingly reinforced.

In one advantageous embodiment, the invention provides for the means to be at least partially integrated in the base section or in the toothing sections. Normally a toothed element or component comprises, for example, a gearwheel or a gear rack, a base part or a base body a toothing section comprising teeth, which protrudes from said base part or base body. In one embodiment, the means are integrated in the base region. Said means can thereby be disposed symmetrically or asymmetrically. In another embodiment, said means are configured in the toothing section. In a preferred embodiment, the means are configured in said toothing section as well as in the base section in order to reduce the risk of breakage to the toothing system as effectively as possible. The means can comprise a plurality of reinforcing bodies, which are at least partially coupled to one another. Alternatively, the reinforcing bodies are configured apart from one another. In one preferred embodiment, the means are designed as a one-piece reinforcing body. Said body is shaped so as to extend at least partially over the base section and the toothing section. The reinforcing body is preferably matched to a contour of the toothing region, for example, as an annular body in the case of a gearwheel. The annular body runs approximately in a wave-shaped manner in one embodiment, wherein the wave crests protrude into the toothing section and wave troughs into the base section. In another preferred embodiment, molded-on elements or projections are configured on the toothing body. As a result, said toothing body extends, for example, in the base section. The molded-on elements or projections protrude at least partially into the toothing section, i.e. into the individual teeth.

In another preferred embodiment, the toothing region consists substantially of a thermoplastic material, whereby an easy construction method can be implemented. In addition, the toothing region having this material can be easily produced in series production. Provision can be made for other materials to be used. A suitable material pairing between toothing region and reinforcing body is selected so that a suitable composite toothing region can be realized.

Provision is therefore made in one advantageous embodiment for the means to be produced from a more durable material vis-á-vis the material of the toothing region, in particular vis-á-vis thermoplastic material. This group of materials particularly comprises steel, sintered steel, thermoset materials and the like. Optimal composite toothing regions can be implemented in a starter using these parent material or material pairings.

The invention preferably provides for the means to be inserted, pressed and/or integrated into the toothing region by means of injection molding as, for example, insert molding. In this way, a simple production of an intermediate bearing device according to the invention can be implemented. In one embodiment of the invention, the means are retroactively introduced into the toothing region. Relevant toothing regions are therefore designed such that they can be retrofitted. The ring is preferably designed as an insert. In one embodiment, a thermoplastic material is injection-molded around said insert.

In a further advantageous embodiment of the invention, provision is made for the means to have recesses, in which the material of the toothing region, i.e. a toothing body, at least partially protrudes, for an optimized integration of said means into the toothing region. An improved cross-linking of the material for said toothing region around and/or through the reinforcing body can be implemented by means of recesses or gaps as, for instance, through-openings. Said reinforcing body is, for example, enhanced by being surrounded by thermoplastic material. In so doing, an improved anchoring of said reinforcing body in the intermediate boy is ensured.

Not least, provision is made in a further advantageous embodiment for the toothing region to be configured as an annular gearwheel-hollow carrier and for the means, which are configured as a circumferential ring in the base section having molded-on elements protruding into the toothing sections, to be integrated, such that said means substantially extend in the peripheral and radial direction in the toothing region. In this way, the intermediate bearing is configured for optimal use in a starter motor.

The cranking apparatus, particularly a starter for cranking an internal combustion engine, said apparatus comprising an intermediate bearing having a bearing location for an output shaft, wherein the intermediate bearing is embodied as an intermediate bearing device, which comprises a toothing region with a base section and toothing sections formed thereon, for receiving gearwheels in a bearing manner, wherein the toothing region is formed as a composite toothing region, in which means for increasing a toothing strength are integrated, has the advantage in relation to the prior art that breakage to the teeth on the intermediate bearing is effectively prevented and thus the service life of a cranking apparatus is significantly increased. In addition, the number and frequency of the maintenance intervals are reduced.

The inventive system comprising an internal combustion engine and a starter for cranking the internal combustion engine, wherein the starter for cranking the internal combustion engine is embodied as a cranking apparatus comprising an intermediate bearing having a bearing location for an output shaft, wherein the intermediate bearing is embodied as an intermediate bearing device, comprising a toothing region with a base section and toothing sections formed thereon, for receiving gearwheels in a bearing manner, wherein the toothing region is formed as a composite toothing region, in which means for increasing a toothing strength are integrated, has the advantage in relation to the prior art that such a system including said means for increasing a toothing strength can be easily retrofitted, has an enhanced service life, experiences fewer disturbances to operational events and allows itself to be easily assembled in a simple manner.

### BRIEF DESCRIPTION OF THE DRAWINGS

Exemplary embodiments of the invention are depicted in the drawings and are explained in detail in the following description. The following are shown:

FIG. 1 a partially cutaway, perspective view of an intermediate bearing device,

FIG. 2 a partially cutaway, perspective view of another embodiment of an intermediate bearing device,

FIG. 3 a partially cutaway, perspective view of a further embodiment of an intermediate bearing device,

FIG. 4 a partially cutaway, perspective view of a further embodiment of an intermediate bearing device and

FIG. 5 a detail of a composite toothing region in a cross-sectional view.

### DETAILED DESCRIPTION

FIG. 1 shows a partially cutaway, perspective view of an intermediate bearing device 1 for a cranking apparatus, particularly for a starter for cranking an internal combustion engine. The intermediate bearing device comprises a somewhat cup-shaped intermediate bearing 2 having an annular toothing region 3. The toothing region 3 comprises a substantially annular base section 4 and toothing sections 5, which are configured as teeth 5a protruding from the base section 4 radially towards the inside. A variety of different molded-on elements 5b protrude radially away from the base section 4 towards the outside. An approximately annular reinforcing body 6, which forms a means for increasing a toothing strength, is integrated into said toothing region 3. The reinforcing body 6 extends in an axial direction of the intermediate bearing device approximately at a right angle to a base of the cup-shaped intermediate bearing 2 approximately over the entire width of the toothing section 5. In so doing, said reinforcing body 6 is approximately flush with the toothing section 3 at an end face, so that said reinforcing body 6 is not covered by said toothing section 3. Said reinforcing body 6 is matched to the contour of said toothing section 3 and extends in the peripheral direction over the entire base section 4, which is likewise of annular design. Molded-on elements 7 protrude from said reinforcing body 6 into the individual toothing sections 5 so that said reinforcing body 6 extends radially, peripherally and axially into the contour of the toothing region 3. A reinforcing body 6 not covered by said toothing region 3 in the axial direction can be retroactively integrated into the intermediate bearing 2. A corresponding recess in said intermediate bearing 2 is formed for this purpose. In other embodiments, the reinforcing body 6 is completely enclosed by said toothing region, for example, as a result of being produced as an injection-molded part.

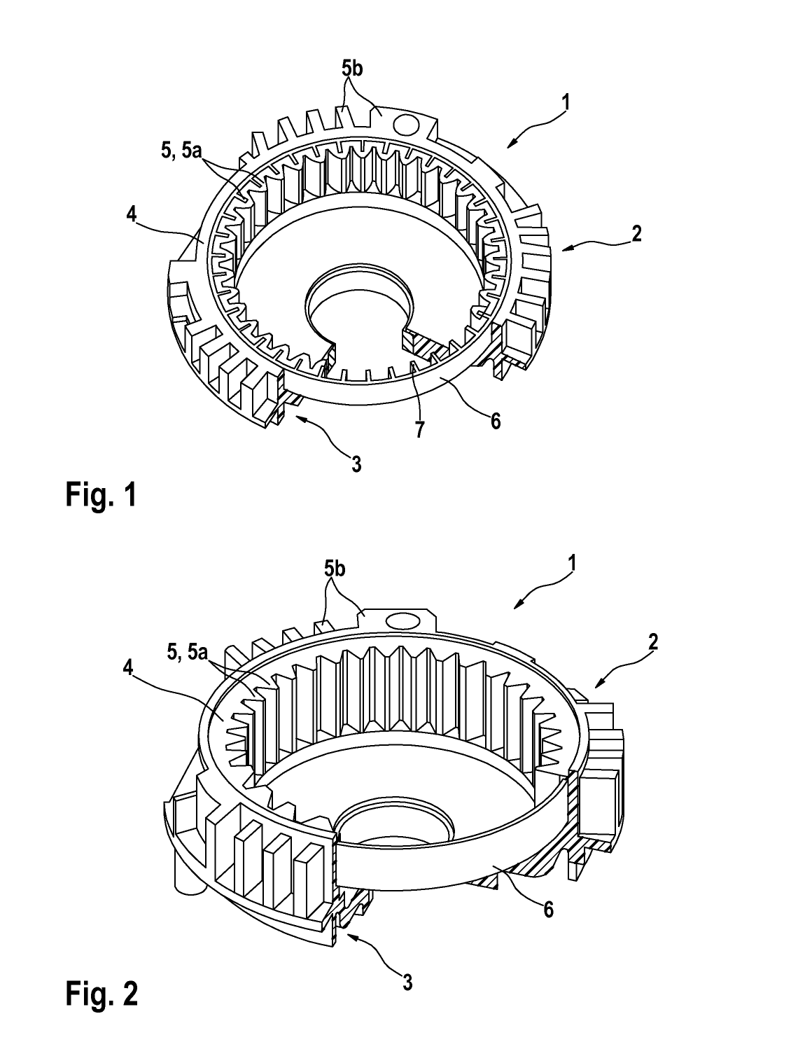

FIG. 2 shows a partially cutaway, perspective view of a further embodiment of an intermediate bearing device 1. The intermediate bearing device 1 is embodied substantially similar to the intermediate bearing device 1 according to FIG. 1. The essential difference between the embodiments according to FIG. 1 and FIG. 2 is that the reinforcing body 6 in the embodiment according to FIG. 2 is completely enclosed by the toothing region 3. In addition, the annular reinforcing body 6 does not have any molded-on elements protruding radially, so that said body only extends in the base section 4 of the toothing region 3.

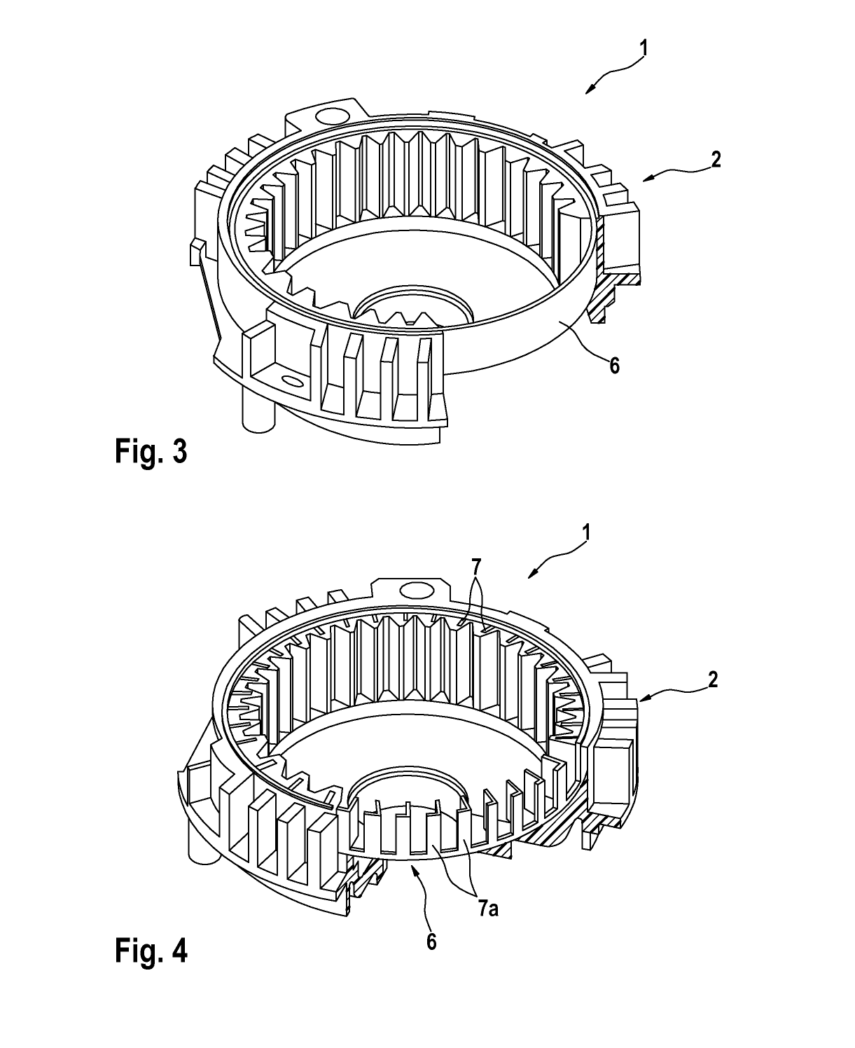

FIG. 3 shows a partially cutaway, perspective view of a further embodiment of an intermediate bearing device 1. The exemplary embodiment according to FIG. 3 represents a combination of the exemplary embodiments according to FIG. 1 and FIG. 2. The intermediate bearing 2 corresponds to the intermediate bearing according to FIG. 1. The annular reinforcing body 6 corresponds to the reinforcing body according to FIG. 2, i.e. said body does not have any radial extensions. Similar to FIG. 1, said reinforcing body 6 is, for example, pressed into a slot-shaped recess of said intermediate bearing 2. That means that the intermediate bearing device 1 according to FIG. 3 corresponds to the intermediate bearing device 1 according to FIG. 1, except that the molded-on elements 7 are not present.

FIG. 4 shows a partially cutaway, perspective view of a further embodiment of an intermediate bearing device 1. The embodiment according to FIG. 4 corresponds substantially to the embodiment according to FIG. 1, except that the reinforcing body 6 including the molded-on elements 7 disposed thereon is differently embodied. The molded-on elements 7 according to FIG. 4 are in one region embodied as L-shaped molded-on elements 7a which protrude in a shovel-like manner. In another region, said molded-on elements 7 are embodied analogously to the molded-on elements according to FIG. 1, i.e. the invention provides for different molded-on elements 7, 7a. In a like fashion, the reinforcing body 6 has different regions, which deviate from one another with respect to the width, i.e. in the axial extension thereof. In one region, the width of the reinforcing body 6 is reduced to a minimum, just sufficient to hold the molded-on elements 7a and connect them to one another. In the other region, the width of the reinforcing body corresponds approximately to that according to FIG. 1, wherein a small projection of the reinforcing body 6 over the toothing region 3 is provided. An enhanced anchoring of the reinforcing body 6 in the intermediate bearing 2 is implemented by the openings thus created in a region of said reinforcing body 6. Hence, the material of said intermediate bearing 2 can better flow around said reinforcing body 6, for example, during production as an injection-molded part, whereby said body is integrated.

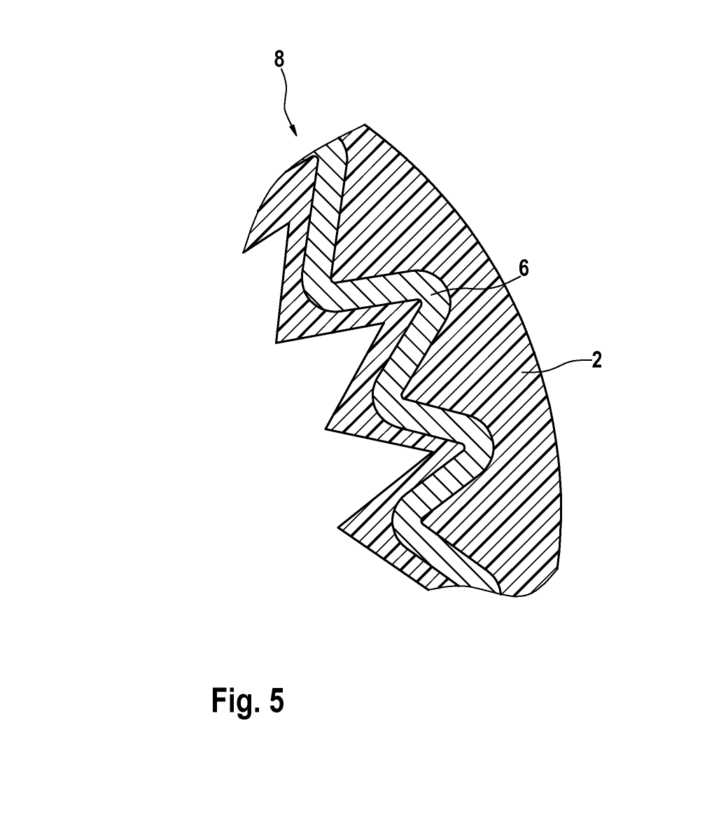

In a sectional view, FIG. 5 shows a detail of a composite toothing region 8. In the depicted region 8, a reinforcing body 6 matched to the toothing geometry of the toothing section 5 and therefore configured somewhat in a zig-zag or serpentine manner, is approximately parallel to an upper surface of the toothing section. The reinforcing body 6 is designed as a metal or steel ring in the exemplary embodiment. The intermediate bearing 2 is designed as a plastic intermediate bearing.

In all of the exemplary embodiments according to FIGS. 1 to 5, the intermediate bearing 2 is produced from a plastic such as a thermoplastic material. The reinforcing body 6 is thereby always configured as a ring made from steel, sintered steel or thermoset material. In the exemplary embodiment according to FIG. 1, the ring is integrated into the intermediate bearing by means of injection molding. Said ring is embodied in FIG. 1 such that it protrudes up into the tips of the teeth. In a second embodiment, the ring is embodied such that it does not protrude into the tips of the teeth, but only stabilizes the periphery of the toothing region (exemplary embodiment according to FIG. 2). In the third exemplary embodiment, the ring is embodied such that it is not pressed into the intermediate lager 2 until after said intermediate bearing 2 has been injection-molded (exemplary embodiment according to FIG. 3). In order to facilitate the press-in operation, the ring has in this case no molded-on elements 7, 7a. Due to the higher strength and temperature resistance of the ring material with respect to the thermoplastic material of said intermediate bearing 2, a breakage to the toothing is prevented. Even if the ring does not protrude up into the tips of the intermediate bearing toothing, said intermediate bearing 2 is stabilized under load and heat input. When the thermoplastic material is heated, the tensile strength thereof is reduced. The toothing then becomes soft and deforms. This is prevented by a ring consisting of temperature resistant material, which is either embedded or pressed in. In the fourth exemplary embodiment, the ring has openings. The ring is thereby better surrounded by the injected thermoplastic material (exemplary embodiment according to FIG. 4). The anchoring of said ring in the intermediate bearing 2 is thereby even better ensured.

1. An intermediate bearing device (1) for a cranking apparatus, comprising a toothing region (3) with a base section (4) and toothing sections (5) formed thereon, for receiving gearwheels in a bearing manner, characterized in that the toothing region (3) is formed as a composite toothing region (8), in which means for increasing a toothing strength are integrated.

2. The intermediate bearing device (1) according to claim 1, characterized in that the means for increasing a toothing strength include as at least one reinforcing body (6) which is at least partially matched to a contour of the toothing region (3).

3. The intermediate bearing device (1) according to claim 1, characterized in that at least one of the composite toothing region (8) and the means for increasing a toothing strength extends over the entire toothing region (3).

4. The intermediate bearing device (1) according to claim 1, characterized in that the means for increasing a toothing strength are integrated at least partially in at least one of the base section (4) and in the toothing sections (5).

5. The intermediate bearing device (1) according to claim 1, characterized in that the toothing region (3) consists substantially of a thermoplastic material.

6. The intermediate bearing device (1) according to claim 1, characterized in that the means for increasing a toothing strength are produced from a more durable material with respect to the material of the toothing region (3).

7. The intermediate bearing device (1) according to claim 1, characterized in that the means for increasing a toothing strength are inserted, pressed and/or integrated into the toothing region (3) by means of injection molding.

8. The intermediate bearing device (1) according to claim 1, characterized in that the means for increasing a toothing strength have recesses, in which the material of the toothing region (3) at least partially protrudes, for an optimized integration of said means into said toothing region (3).

9. The intermediate bearing device (1) according to claim 1, characterized in that the toothing region (3) includes as an annular gearwheel-hollow carrier and the means for increasing a toothing strength, which are configured as a circumferential ring in the base section (4) having molded-on elements (7, 7a) protruding into the toothing sections (5), are integrated such that said means substantially extend in the peripheral and radial direction in the toothing region (3).

10. A cranking apparatus, comprising an intermediate bearing having a bearing location for an output shaft, characterized in that the intermediate bearing includes as an intermediate bearing device (1), comprising a toothing region (3) with a base section (4) and toothing sections (5) formed thereon, for receiving gearwheels in a bearing manner, wherein the toothing region (3) is configured as a composite toothing region (8), in which means for increasing a toothing strength are integrated.

11. A system comprising an internal combustion engine and a starter for cranking the internal combustion engine, characterized in that the starter for cranking said internal combustion engine includes as a cranking apparatus comprising an intermediate bearing having a bearing location for an output shaft, wherein the intermediate bearing is includes as an intermediate bearing device (1), comprising a toothing region (3) with a base section (4) and toothing sections (5) formed thereon, for receiving gearwheels in a bearing manner, wherein the toothing region (3) is configured as composite toothing region (8), in which means for increasing a toothing strength are integrated.

12. The intermediate bearing device (1) according to claim 1, characterized in that the means for increasing a toothing strength are produced from a more durable material with respect to a thermoplastic material.

13. The intermediate bearing device (1) according to claim 12, wherein said means is selected from a group which comprises steel, sintered steel and thermoset materials.
